(19) United States
(12) Patent Application Publication
(10) Pub. No.: US 2026/0192442 A1
(43) Pub. Date: Jul. 9, 2026

(54) VINE ROBOT WITH COMPRESSED TAIL

(71) Applicant: The Regents of the University of California, Oakland, CA (US)

(72) Inventors: Cedric Girerd, Artemare (FR); Tania K. Morimoto, San Diego, CA (US); Elliot Wright Hawkes, Goleta, CA (US)

(21) Appl. No.: 19/133,068

(22) PCT Filed: Nov. 28, 2023
(86) PCT No.: PCT/US2023/081423

§ 371 Date: May 27, 2025

Related U.S. Application Data
(60) Provisional application No. 63/429,263, filed on Dec. 1, 2022.

(51) Int. Cl. B25J 9/14; B25J 18/02; B25J 18/06

(52) U.S. Cl. CPC B25J 9/142; B25J 18/02; B25J 18/06

(57) ABSTRACT

A soft vine robot includes a soft main body having a base portion, a middle portion and a tail portion. The main body is configured to grow into a constrained environment with the tail portion extending further into the constrained environment than the middle and base portions. A compressed portion is in the tail portion. The compressed portion is configured to decompress and extend into the constrained environment. The compressed portion permits further extension with less friction than experienced during an eversion process. Both everting and non-everting designs with compressed tail portions are provided. A constraining tube around the compressed tail portion resists radial expansion of the compressed portion.

### PRIORITY CLAIM AND REFERENCE TO RELATED APPLICATION

The application claims priority under 35 U.S.C. § 119 and all applicable statutes and treaties from prior U.S. provisional application Ser. No. 64/429,263, which was filed Dec. 1, 2022.

### STATEMENT OF GOVERNMENT INTEREST

This invention was made with government support under EB032417 awarded by the National Institutes of Health, and 1944816 awarded by the National Science Foundation. The government has certain rights in the invention.

### FIELD

A field of the invention is everting robots, also referred to as vine robots.

### BACKGROUND

Vine robots are formed of soft materials and evert in response to fluid pressure. Specifically, a vine robot extends from its tip by everting or unfurling new material, driven by internal body pressure. See, e.g. Hawkes et al., U.S. Pat. No. 10,954,789. Vine robots typically store new body material in a reel at their base, which material is unreeled as the robot is extended and everts in response to fluid pressure passing it through the core of the robot to the tip. Made of a thin-walled membrane inverted inside itself, these robots “grow” when inflated, passing new material through the body to emerge at the tip to achieve extension. Their bodies do not move relative to their surroundings.

One problem inherent to the vine robot designs is friction. Additional critical problems include an inability to provide a working channel in common designs and challenges of doing so at smaller and smaller scales. Typical vine growing robots are made of a thin plastic tube which is everted. The layer of material located in the outside is called the body, and the part that is everted inside it is called the tail. By pressurizing the vine, its tail translates along its body and everts at the tip. This enables vine robots to locomote by growth at the tip instead of translating along their entire length with respect to the environment. However, the growth length of these robots is limited by the friction between their body and their tail, which are in contact and are required to move relatively to one another for growth.

Example prior designs include mechanisms to overcome problems related to friction. S. Wang, R. Zhang, D. A. Haggerty, N. D. Naclerio, and E. W. Hawkes, “A dexterous tip-extending robot with variable-length shape-locking,” in 2020 IEEE International Conference on Robotics and Automation (ICRA). IEEE, 2020, pp. 9035-9041. Another design used discrete, reversible body stiffness modulation. B. H. Do, V. Banashek, and A. M. Okamura, “Dynamically reconfigurable discrete distributed stiffness for inflated beam robots,” in 2020 IEEE International Conference on Robotics and Automation (ICRA). IEEE, 2020, pp. 9050-9056. An additional design used mechanical interlocks. W. Hawkes, L. H. Blumenschein, J. D. Greer, and A. M. Okamura, “A soft robot that navigates its environment through growth,” Science Robotics, vol. 2, no. 8, p. eaan3028, 2017. Another used active and programmable heat sealing. Y. Satake, A. Takanishi, and H. Ishii, “Novel growing robot with inflatable structure and heat-welding rotation mechanism,” IEEE/ASME Transactions on Mechatronics, vol. 25, no. 4, pp. 1869-1877, 2020. These designs fail to provide flexible active control of growth direction and/or materially alter the nature of vine robot growth.

Material scrunching, i.e., folded or deformed into a compressed state, has been described for vine growing robots. See, J.-H. Kim, J. Jang, S.-m. Lee, S.-G. Jeong, Y.-J. Kim, and J.-H. Ryu, “Origami-inspired new material feeding mechanism for soft growing robots to keep the camera stay at the tip by securing its path,” IEEE Robotics and Automation Letters, vol. 6, no. 3, pp. 4592-4599, 2021; M. Shike, Z. Fireman, R. Eliakim, O. Segol, A. Sloyer, L. B. Cohen, S. Goldfarb-Albak, and A. Repici, “Sightline colonosight system for a disposable, power-assisted, non-fiber-optic colonoscopy (with video),” Gastrointestinal Endoscopy, vol. 68, no. 4, pp. 701-710, 2008. In this design, the vine was scrunched at intermediate locations along the body or at the base of the vine, as a replacement to spools typically used to store the tail material. The goal of the later approach was to ease the passage of camera wires through the tail.

### SUMMARY OF THE INVENTION

A preferred embodiment provides a soft vine robot includes a soft main body having a base portion, a middle portion and a tail portion. The main body is configured to grow into a constrained environment with the tail portion extending further into the constrained environment than the middle and base portions. A compressed portion is in the tail portion. The compressed portion is configured to decompress and extend into the constrained environment. The compressed portion permits further extension with less friction than experienced during an eversion process. Embodiments include everting and non-everting designs with compressed tail portions. A constraining tube around the compressed tail portion resists radial expansion of the compressed portion.

### BRIEF DESCRIPTION OF THE DRAWINGS

FIGS. 1A-1C show a preferred embodiment everting compressed tail soft vine robot;

FIGS. 2A-2C show a preferred embodiment non-everting compressed tail soft vine robot;

FIGS. 3A-3D show a model for growth of an everting vine growing robot with a working channel at two different growth stages; Specifically, FIG. 3A is cross-sectional schematic drawing of a growing vine robot; 3B is a cross-sectional schematic drawing of the forces present in the growing vine robot of FIG. 3A; FIG. 3C is cross-sectional drawing taken through line A-A in FIG. 3A; FIG. 3D is cross-section drawing taken through line D-D in FIG. 3A;

FIG. 4 is a graph showing growth pressure over time for mathematically modeled vine robots of different lengths, showing that growth pressure increases as scale decreases;

FIGS. 5A-5B illustrates dimension labels (FIG. 5A) and forces (FIG. 5B) for the everting compressed tail vine growing robot with a working channel at two different growth stages; Specifically, FIG. 5A is cross-sectional schematic drawing of a growing vine robot; FIG. 5B is a cross-sectional schematic drawing of the forces present in the growing vine robot of FIG. 5A;

FIGS. 6A-6C are cross-sectional schematic representations of the compressed tail material for the everting compressed tail vine robot at its lowest (FIG. 6A), intermediate (FIG. 6B) and highest compression ratios (FIG. 6C);

FIG. 7 is a graph of data that shows pressure required to grow a 150 mm vine robot as it is scaled down, comparing the standard design to a present everting compressed tail (“scrunched”) design with different compression ratios;

FIG. 8 is a graph of data that shows pressure required to grow as a function of R as the body and material thickness of an everting compressed tail (“scrunched”) vine robot are scaled, while the working channel radius remains constant;

FIGS. 9A-9B illustrates dimension labels (FIG. 9A) and forces (FIG. 9B) for the non-everting compressed tail vine growing robot with a working channel at two different growth stages; Specifically, FIG. 9A is cross-sectional schematic drawing of a growing vine robot; FIG. 9B is a cross-sectional schematic drawing of the forces present in the growing vine robot of FIG. 9A;

FIGS. 10A-10C are schematic cross-sectional representations of compressed tail material for the non-everting compressed tail vine robot for minimum (FIG. 10A), intermediate (FIG. 10B) and maximum (FIG. 10C) compression states;

FIGS. 11A-11B respectively show a schematic front view (FIG. 11A) in the growth direction of the non-everting compressed vine robot and a close-up view (FIG. 11B) which labelled with variables used for modeling purposes;

FIG. 12 is a graph of data that shows variations of compressed material area as a function of radius as the vine robot is scaled down, for different compression ratio;

FIG. 13 is a graph of data that shows variations of maximum radius and area when the vine robot body and material thickness are scaled, while the working channel radius remains constant;

FIG. 14 is a graph of data that shows comparison of the pressure required to grow a 150 mm vine robot as it is scaled down, for the standard design, the everting compressed tail design, and the non-everting compressed tail design;

FIGS. 15A-15E are cross-sectional schematic views that show ordered steps of a preferred fabrication process for the everting compressed tail robot;

FIGS. 16A-16E are cross-sectional schematic views that show ordered steps of a preferred fabrication process for the non-everting compressed tail robot;

FIG. 17 is a graph that shows testing data of required pressures to grow three experimental everting compressed tail robots having difference radii of 3.5 mm, 7.0 mm and 10.5 mm; and

FIG. 18 shows testing data of surface area of scrunched material as a function of compression ratio for three experimental non-everting compressed tail robots.

### DESCRIPTION OF THE PREFERRED EMBODIMENTS

“Compressed” as used herein means that a portion of a robot body is shortened by a regular or irregular pattern of scrunches, folds, or wrinkles, in the material. When the compressed body material decompresses, it can do so in the manner of an accordion, as the folds, wrinkles or deformations straighten.

A preferred embodiment provides a soft vine robot. The robot includes a main body configured as a tube inverted back inside itself to define a pressure channel, such that when the channel is pressurized, the main body everts and passes out of a tip at a distal end of the main body. A tail includes a compressed portion that is compressed prior to deployment to reduce contact during eversion and to extend further after complete eversion, thereby reducing friction and enabling longer growth and/or reduced pressure required to achieve growth. Another preferred embodiment is a non-everting vine robot. It includes a tail portion that is compressed prior to deployment to reduce friction and the vine body in-line with it.

A preferred tail structure includes or consists of a portion of scrunched, folded or wrinkled material at the tail. The tail portion can be inverted inside the body, or in line with the body, without material inversion. The reduced friction enables the vine robot to deploy a longer length or a comparable length with less pressure required for growth compared to a prior vine robot with a smooth/uncompressed tail. The compressed tail portion reduces friction between the tail and a working channel or the robot body.

The compressed tail material can also serve to pass tools. A preferred vine robot includes a compressed tail and one or more components that stay at the tip in the compressed tail while allowing standard eversion of the tail albeit with reduced friction. To interact with the environment, these components need to be inserted through the tail. However, vine robots need to be pressurized to grow, which presses the tail onto the embedded component along the entire tail length. Compressed tail material leads to a lower contact length and enables the tail with embedded components to deploy for a longer length or for a similar length at lower pressure. The tail can be used to deliver tools, or tools can be delivered through a working channel of the vine robot. See, e.g., WO2022132400, Vine Robot Catheter Device that discusses tool delivery in a vine robot.

A preferred embodiment vine robot with a compressed tail portion was demonstrated experimentally. The vine robot included a working channel inside the vine tail. A portion of the vine tail was compressed with scrunched material adjacent and at the distal tip of the vine robot. A layer of material covered the scrunched tail material to limit its radial expansion, so that friction with the body remains low. This tail scrunching enabled a shorter friction length between the tail and the working channel and between the vine tail and the vine body, leading to an overall longer deployed length.

A preferred embodiment is a scaled down diameter vine growing robot, which can deploy at a given pressure for a desired length that exceeds prior vine robots due to its compressed tail. In the experimental vine robot, the tail was scrunched around a thin rod at the tip of the vine, with a layer of material around it to prevent its radial expansion, which reduces friction between the vine body and the tail portion during eversion.

Preferred robot designs can have very small diameters, which is necessary, for example in application to minimally invasive surgery, where the ability to safely navigate through small highly constrained environments is critical. Lower pressure to achieve a given amount of extension provides an additional measure of safety. An example non-everting vine robots of the present invention was fabricated with a diameter of 2.22 mm for the body and 3.20 mm at the tip, where the material is scrunched and occupies a larger diameter prior to deployment.

Preferred embodiments of the invention will now be discussed with respect to experiments and drawings. Broader aspects of the invention will be understood by artisans in view of the general knowledge in the art and the description of the experiments that follows.

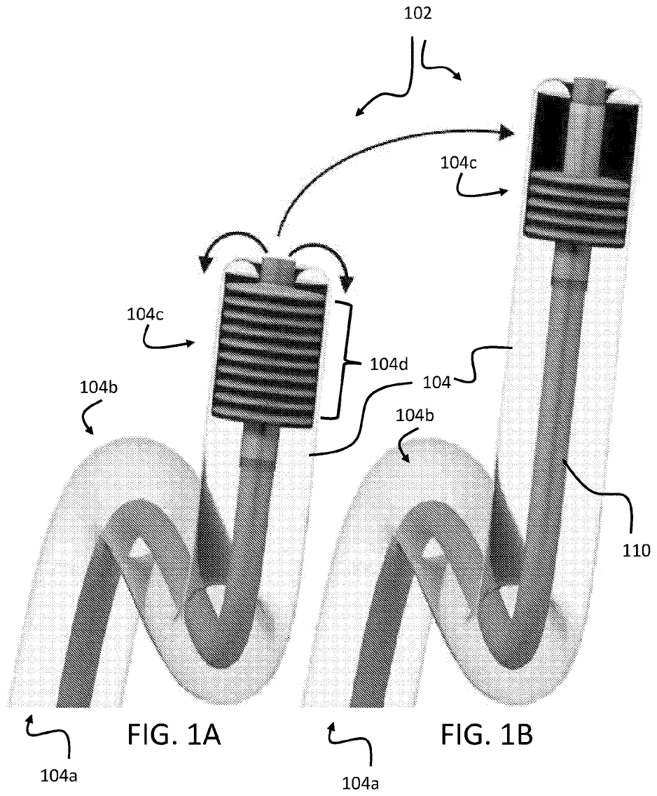

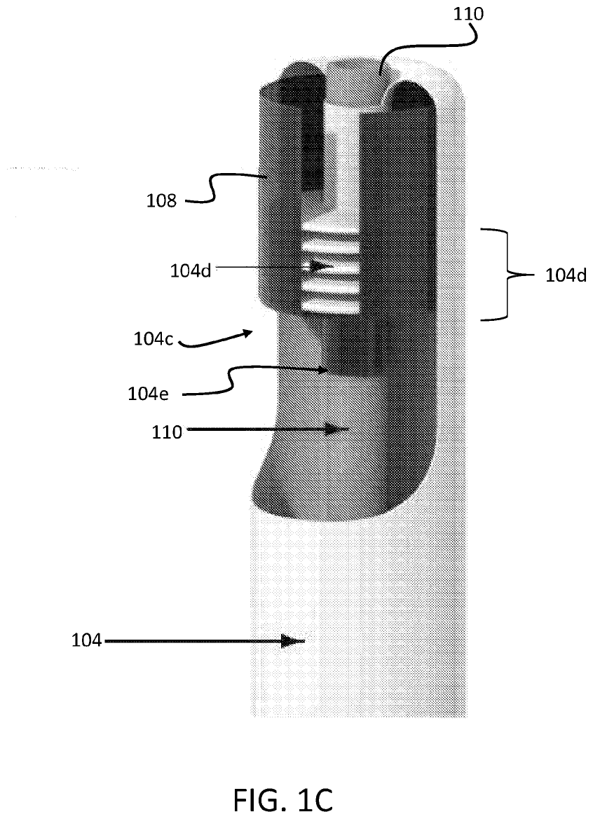

FIGS. 1A-IC show a preferred embodiment soft vine robot 102. The robot 102 includes a soft main body 104 having a base portion 104a, a middle portion 104b and a tail portion 104c. The main body 104 is configured to grow into a constrained environment with the tail portion 104c extending further into the constrained environment than the middle 104b and base portions 104a. The tail portion 104c includes a compressed portion 104d of scrunched body material. The compressed portion 104d is configured to decompress (as shown partially decompressed in FIG. 1B) to provide further extension into the constrained environment.

FIG. 1A shows the state where the tail portion 104c begins to evert. Eversion continues until the compressed portion 104d is exposed, and then further growth occurs by decompression of the compressed portion 104d, without further eversion. FIG. 1B shows a state of partial decompression, where a portion of the compressed portion 104d has been decompressed. Further growth of the soft robot can continue until full decompression of the portion 104d.

FIG. 1C shows the tail portion 104c and its compressed portion 104d in more detail. The compressed portion 104d, while in its inverted position, is constrained by a constraining tube 108 to prevent its radial relaxation/expansion while it is inverted. The constraining tube 108 should withstand radial expansion forces from the compressed portion 104d, which exerts radial forces from the inside. Thus, constraining tube 108 should not be stretchable so that it doesn't expand radially, which serves to prevent contacts between the constraining tube 108 and the vine robot body 104. Material of the vine robot 104 material can be used if it provides such characteristics. Experiments used Dyneema® fiber reinforced fabric for both the robot body 104 and the constraining tube. When the vine body 104 is very thin such that it could deform, then a thicker version of the same material can be used for the constraining tube 108. An unstretchable thin material is preferred since it saves space and provides more room for the compressed tail material 104d compared to a thicker material. FIG. 1C also illustrates a working channel 110, which should withstand radial compression forces from around it due to the scrunched material pressing on it. A tube that forms the working channel 110 should be thicker and/or made of stiffer material to withstand such forces. The constraining tube 108 and an end of the tail 104c are attached to the working tube 110 at connection point 104e.

The tube of the working channel 110 is a radially rigid component crossing the robot. The working channel 110 allows for swapping of tools inside the working channel. If no swapping is required, a tool itself (for example a flexible tube with a gripper at the tip, actuated with tendons located inside the tube) can replace the working channel, and the constraining layer would be attached to it.

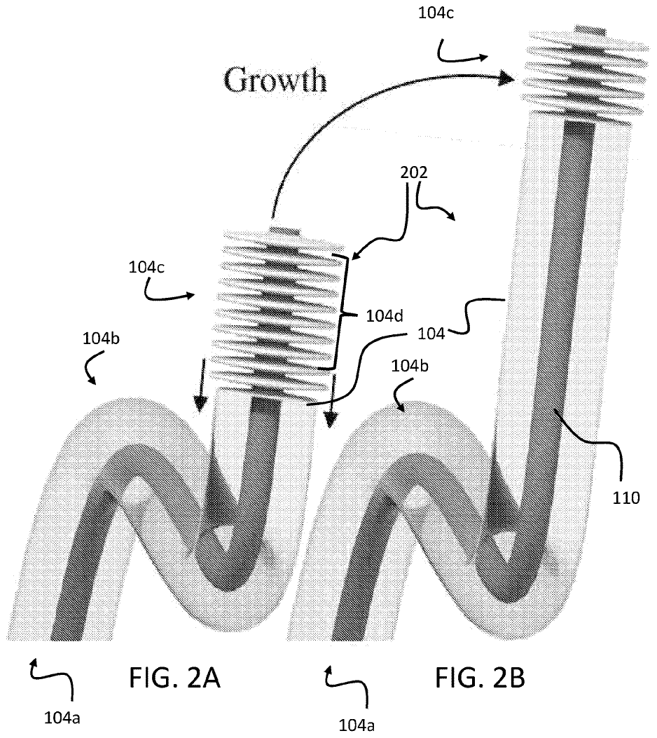

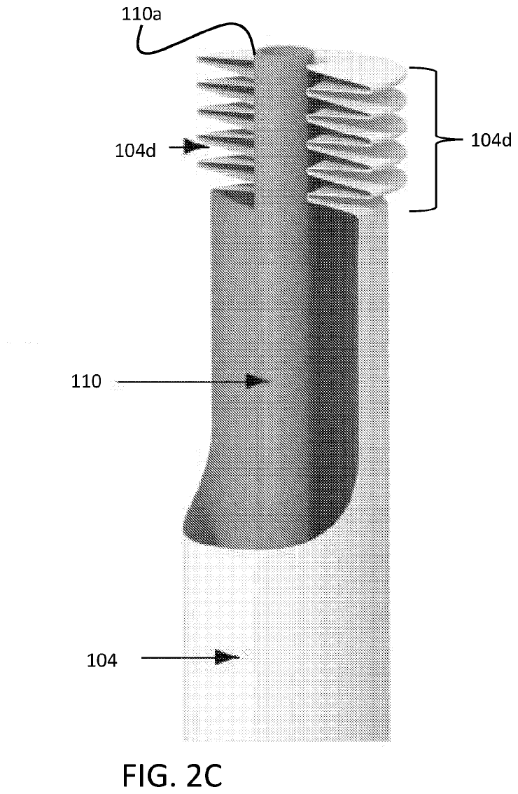

FIGS. 2A-2C show another preferred embodiment soft vine robot 202. Reference numbers are used from FIGS. 1A-1C to identify corresponding portions of the soft vine robot 202. The vine robot 202 is a non-everting soft robot. Growth is provided by the decompression of the compressed portion 104d instead of eversion as material unfolds from the proximal end of the compressed portion 104d. FIG. 2A shows the robot 202 prior to any decompression of the compressed portion 104d, and FIG. 2B shows growth by decompression of a portion of the compressed portion 104d. Growth can continue until the compressed portion 104d is fully decompressed. The non-everting robot 202 has an attachment point 110a that attaches a distal end of the working tube 110 to a distal end of the compressed portion 104d.

Preferred vine robots overcome limits of prior vine robots. This will be appreciated by artisans in view of the following analysis, which begins with a general model for vine robots.

### General Vine Robot Modeling

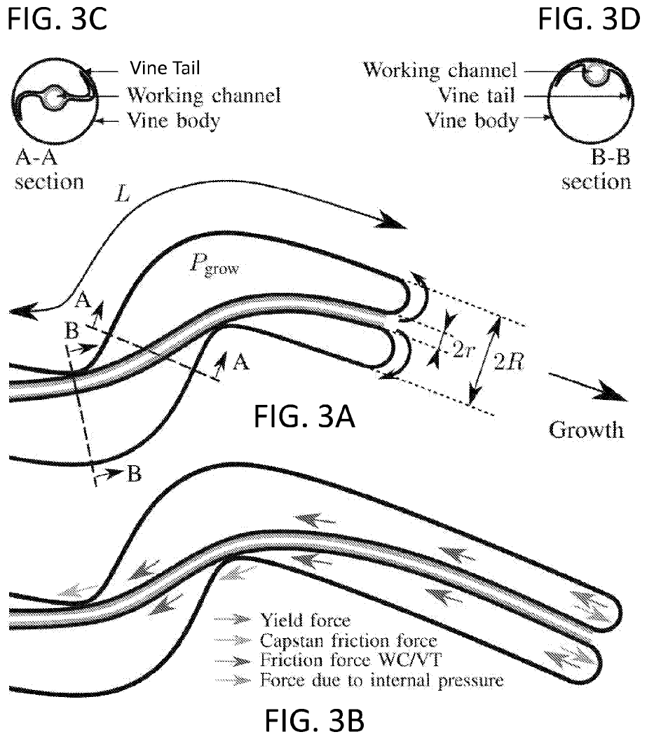

FIGS. 3A-3D show a model for growth of an everting vine growing robot with a working channel at two different growth stages, with its design parameters represented in FIG. 3A and a free body diagram illustrating the forces in FIG. 3B. The A-A cross-section in FIG. 3C illustrates the contact between the vine robot tail and its body in straight path, with the tail and working channel remaining mostly centered inside the vine body, and the B-B cross-section in FIG. 3D illustrates the contact area between the vine robot tail and its body in curved path, with the working channel and vine tail touching the inside of the curved vine body.

Soft growing robots are made from an inextensible, thin-walled material that is formed into a tube. One approach for achieving tip-extension, is to invert one end of the robot material back inside the main body. This inverted material is often called the tail of the vine robot-then everts from the robot tip when an internal pressure is applied. The modeling of such vine growing robots was inspired by growing plants, and has been extended to include a working channel. The model is obtained through a quasi-static analysis of forces acting on the vine robot tail. Without any model simplifications, for a vine robot with radius, R, and a working channel with radius, r, the growth model is given as follows:

$${\underbrace{\frac{1}{2} {P}_{grow} π ( {R}^{2} - {r}^{2} ) + {F}_{Push}}}_{Driving Forces} = {\underbrace{[ \frac{1}{2} {F}_{y} + {( \frac{1}{φ} v )}^{\frac{1}{n}} π ( {R}^{2} - {r}^{2} ) ]}}_{Path - Independent Opposing Forces} , + {\underbrace{[ {μ}_{\frac{VT}{WC}} {P}_{grow} 2 π rL + {μ}_{\frac{VT}{{VB}_{s}}} wL + {Ce}^{{μ}_{\frac{VT}{VB}} Γ} ]}}_{Path - Dependent Opposing Forces} , \qquad ( 1 )$$

On the left-hand side of the equation are the driving forces, which lead to growth. The first term describes the growth force related to the internal pressure of the vine robot, P_{grow}, applied to its cross section. The second term describes the force, Fₚᵤₛₕ, transmitted by the working channel to the vine robot tail. On the right-hand side of Eq. (1) are the forces opposing growth, and these can be classified as path-independent and path-dependent forces. The first path-independent term, ½F_{y}, characterizes the yield force required for material eversion at the tip. The second path-independent term is velocity dependent and models viscoplastic effects as the deployment speed at the vine robot tip, ν, increases, where φ is an extensibility term and n is a coefficient close to unity. The first path-dependent term models the friction between the vine robot tail and the working channel. The working channel needs to travel at half the speed of the tail to be aligned with the vine robot tip, which requires a relative motion between the tail and the working channel, and friction forces between them must be overcome. Considering working channels that have cylindrical cross-sections, their surface area is equal to 2πrL. The normal force exerted by the vine robot tail on the working channel is P_{grow} 2πrL, and the tangential force is obtained by multiplying by the friction coefficient between the working channel and vine tail materials (μ_{VT/wC}), leading to μ_{VT/wC}P_{grow} 2πrL. Note that F_{Push} is bounded by μ_{VT/wC}P_{grow} 2πrL in magnitude, since sliding motions appear for pushing forces of larger magnitude on the working channel. The second path-dependent term models the friction between the tail and the body of the robot in straight paths, where μ_{VT/VB}_{ₛ} is the friction coefficient between the tail and body materials, and w is the unit force exerted by the tail on the vine robot body. The third path-dependent term corresponds to added friction in curved parts of the vine robot body, where tension in the tail due to pressure at the vine robot tip presses the tail towards the inside of the curved vine robot body. In this term, C is a tension force, μ_{VT/VB}_{_{c}} is the friction coefficient between the tail and body materials due to curvature, and F is the total angle swept by all turns of the path. This vine robot design with a working channel through the tail will be referred to below as the “standard design”.

Starting with the general model given by Eq. (1), one can consider the following assumptions. First, the relatively slow growth case such that the velocity-dependent term in Eq. (1) is negligible. In addition, the friction force between the vine robot tail and its body along straight paths is very small compared to the other contributors in Eq. (1). Finally, neglect pushing forces applied by the working channel to the vine tail as assisting growth of the robot, since this would lead to the working channel extending past the tip of the robot during deployment. Thus, set F_{WC/VT}=0. With these assumptions, Eq. (1) becomes:

$$\frac{1}{2} {P}_{grow} π ( {R}^{2} - {r}^{2} ) = \frac{1}{2} {F}_{y} + {μ}_{\frac{VT}{WC}} {P}_{grow} 2 π rL + {Ce}^{{μ}_{VT} {N}_{{B}_{c}} Γ} \qquad ( 2 )$$

Note that in this quasi-static case, where the growth speed of the robot is low, so one can assume that the compressibility of the media used inside the vine does not play a role in the robot behavior, and either air or water could be used as the medium used to apply pressure for eversion of the robot.

### Scaling and Growth Length Limitations

An important application of robots of the invention is miniaturized vine robots (small diameters) with relatively long lengths, so first analyze the growth limitations as vine robots are isometrically scaled in the radial direction (i.e. r/R and t/R fixed). To do so, rearrange Eq. (2) to solve for the growth pressure, which must be below the burst pressure for viable growth. To help with analysis, one can seek to understand how all terms scale as the size of the vine robot changes. In particular, for the yield force, F_{y}, previous work found that it is independent of the robot cross-sectional area. However, through experimentation, it was found that it depends on the thickness of the vine body material approximately as F_{y}=kt² for low density polyethylene (LDPE), where t is the thickness of the vine material and k is an empirically determined constant. The tension force C in the Capstan force is assumed to be scale independent. Eq. (2) can then be rewritten in order to obtain the growth pressure, P_{grow} of a vine robot, and is given as:

$${P}_{grow} = \frac{{kt}^{2} + {Ce}^{{μ}_{\frac{VT}{{B}_{c}}} Γ}}{π ( {R}^{2} - {r}^{2} ) - {μ}_{\frac{VT}{WC}} 4 π rL} \qquad ( 3 )$$

Our model in Eq. (3) is receptive to other materials if future work characterizes their yield forces. Using Eq. (3), one can assess the change in growth pressure as vine robots are scaled. For α∈[0,1], P_{grow} (αR,αr,αt)≥P_{grow} (R,r,t), and thus vine robots that are scaled down require a larger pressure to grow. Equivalently, this means that for a given pressure, scaled vine robots can only grow for a shorter length.

To understand this result, note that the pressure will tend towards infinity as the second term in the denominator of Eq. (3) (μ_{VT/WC}4πrL) approaches the first term (π(R²−r²)). While the first term in the numerator and the first term in the denominator depend on the square of the scale, the second term in the denominator depends linearly. This means that the second term, which represents the internal friction between the tail and the working channel, will become relatively larger during down-scaling and must be mitigated to enable small scale vine robots with working channels. Lastly, the second term in the numerator, which represents the capstan friction in the presence of curves, is scale-independent, meaning that as a vine robot is scaled down, the additional pressure required to grow through a curved path compared to a straight path increases, such that down-scaling vine robots is more limited when curves are added to the path.

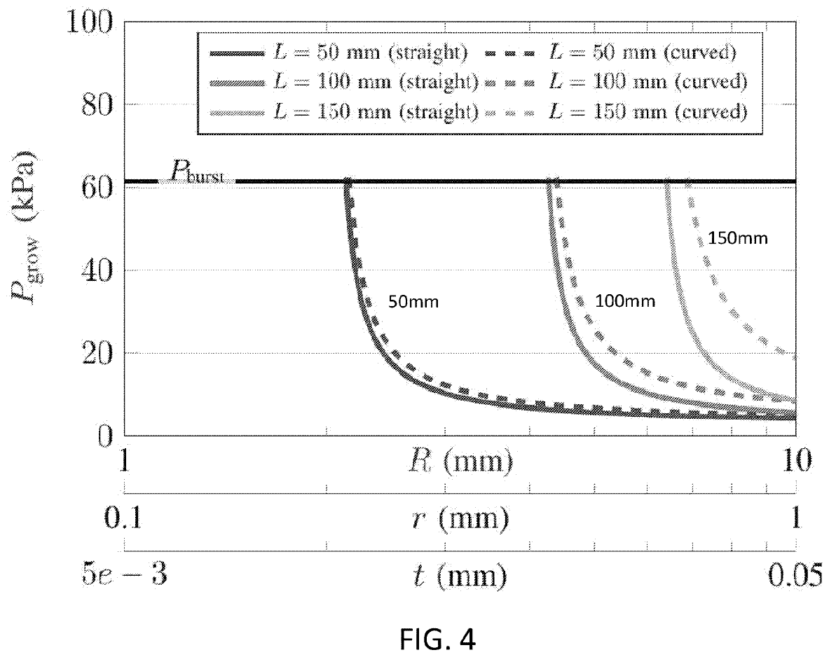

FIG. 4 illustrates that the model shows that for vine robots with working channels, the growth pressure increases as scale decreases. Shorter vine robots have lower growth pressures and can thus be scaled smaller before reaching the burst pressure. Straight vine robots (solid lines) require less pressure to grow than curved ones (dotted lines, radius of curvature=12 mm). Scaling is isometric in the cross section, with working channel radius, main body radius, and material thickness scaling together.

In FIG. 4, an increase in growth pressure for a vine robot as its cross section is scaled down is apparent, for the case of both curved (dotted lines) and straight (solid line) paths. The robot selected has the following parameters: r/R=0.1, μ_{VT/WC}=0.1, material is LDPE with t/R=0.005. For simulations along curved paths, consider μ_{VT/VB}_{_{c}}=0.22 and C=0.08, as previously estimated. Define the radius of curvature of the path to be 12 mm such that the vine robot shape does two full revolutions for the longest deployed length considered (L=150 mm). The burst pressure was estimated by pressurizing 5 LDPE tubes of diameter 31.8 mm and thickness 50.8 μm until they burst. The average burst pressure measured was 39.2 kPa with a standard deviation of 1.1 kPa. Using the hoop stress equation given as

$${P}_{burst} = {σ}_{yield} ( \frac{t}{R} ) \qquad ( 4 )$$

The material yield stress σ_{yield}=1.23e4 kPa can be determined and leads to P_{burst}=61.3 kPa for our simulations. As seen in FIG. 4, the pressure required to grow a certain length increases as the vine robot is scaled down, and longer lengths cannot be obtained with small vine robots. Finally, the results also show a pressure increase when growing for a given length in curved paths compared to straight paths. The present vine robots 102 and 202 overcome these limitations.

### Everting Compressed Tail Robot (102, FIGS. 1A-1C)

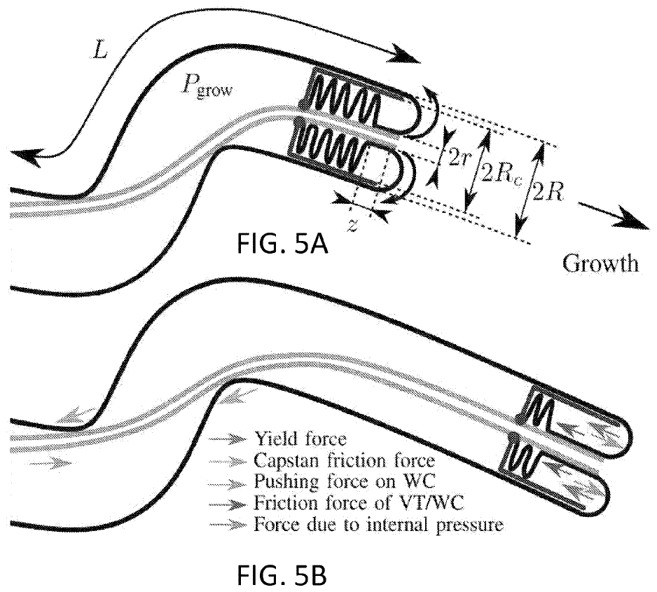

FIGS. 5A-5B illustrates forces for the everting compressed tail vine growing robot with a working channel at two different growth stages, with its design parameters represented in FIG. 5A and free body diagram representing the forces in FIG. 5B. This design lowers the effective contact area between the vine robot tail and both the working channel and vine robot body. To prevent friction between the scrunched tail and the vine robot body, the thin constraining tube 108 (see FIG. 1C), with a radius R_{c}, smaller than that of the vine robot body R, is placed around the compressed material (104d in FIGS. 1A-1C). For analysis, assume that the length of compressed material is sufficiently short with respect to the local radius of curvature of the path, such that the compressed material does not need to bend, and such that there is negligible friction between the constraining layer and the vine body. Also assume that decompressing the material is not impeded by any force, i.e. that the layers of material are not blocked due to the material being tightly packed.

Next, modify Eq. (2) to understand the growth capabilities of the present everting compressed tail design. In order for the vine robot to grow, the pushing force exerted by the internal pressure must overcome the yield force and friction forces between the deploying tail and the tip of the working channel. This leads to a first growth condition, as shown in Eq. (5), top. In addition, the working channel must be pushed in order to stay at the tip of the vine robot, meaning that friction forces between the vine robot body and the working channel, which can appear in straight or curved paths as represented in FIGS. 5A & 5B, must be overcome. Note that pushing the working channel is not used to aid in the growth of the robot, but only to keep its distal end aligned with the robot tip. This leads to a second growth condition, as shown in Eq. (5), bottom. These two conditions of deployment are expressed by the following system:

$$\{ \begin{matrix}\frac{1}{2} {P}_{grow} π ( {R}^{2} - {r}^{2} ) = \frac{1}{2} {F}_{y} + {μ}_{\frac{VT}{WC}} {P}_{grow} 2 π rz \\ {F}_{Push} = {F}_{\frac{WC}{VB}}\end{matrix} , \qquad ( 5 )$$

where z is the contact length between the deploying tail material and the working channel. Assuming that the short compressed section length results in negligible friction in curved paths, the design does not require a pressure increase for growth in curved paths. This is an important benefit, as maintaining a growth pressure well below burst pressure, even in curved paths, is critical for practical applications.

Assume that the pushing force provided at the base of the working channel is large enough to compensate for the friction forces between the working channel and the vine robot body. Therefore focus on the first equation of the system in Eq. (5). The effective friction length between the vine robot tail and the working channel is z, compared to L in previous designs. Since the material is compressed, e z≤; L, and the difference between them depends on how much the material is compressed.

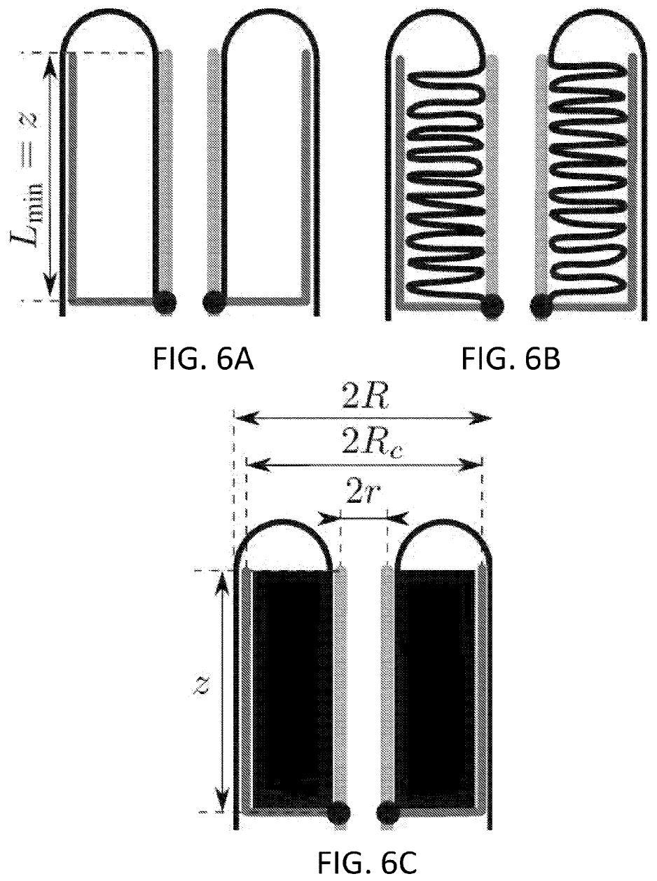

FIGS. 6A-6C are representation of the compressed material with (A) the highest compression ratio ∈=∈ₘᵢₙ, (B) an intermediate compression ratio and (C) the lowest compression ratio ∈ₘₐₓ.

It is convenient to convert the length of compressed material at the tip, z, to a deployed length, L, for the vine robot. The material is scrunched between two cylinders of radius R_{c} and r and length z (FIG. 6C), resulting in a volume of

$$π ( {R}_{c}^{2} - {r}^{2} ) z$$

where the scrunched material can be stored. The volume of material that is stored inside can be expressed as the material cross-section, 2πRt, times its length, L. Assume that the extent to which the scrunched material can be compressed will vary, and define a compression ratio E as the volume occupied by the vine material over the available volume:

$$ϵ = \frac{2 π RtL}{π ( {R}_{c}^{2} - {r}^{2} ) z} . \qquad ( 6 )$$

There must be at least one layer of material inside the material storage area, as shown in FIG. 6A. Therefore, the minimum length of material that can be stored, and thus the minimum growth length, is Lₘᵢₙ=z. This case corresponds to the standard design, when only a layer of material is present along the working channel, without scrunches. This leads to a minimum compression ratio

$${ϵ}_{min} = \frac{2 Rt}{{R}_{c}^{2} - {r}^{2}} .$$

In its most compact form, assume that the volume for material storage is full of material, such that have ∈ₘₐₓ=1, as illustrated in FIG. 6C. This leads to

$${L}_{max} = \frac{( {R}_{c}^{2} - {r}^{2} ) z}{2 Rt} ,$$

which is the maximum length of material which can be stored, and thus the maximum growth length. An illustration of an intermediate case with ∈ₘᵢₙ≤∈≤∈ₘₐₓ is shown in FIG. 6C.

Given that the minimum growth length of our everting scrunched design, Lₘᵢₙ=z, is equal to the growth length of the standard design, the gain, G, in growth length between the designs can be expressed as L/z using Eq. (6) as:

$$G = ϵ ( \frac{{R}_{c}^{2} - {r}^{2}}{2 R t} ) \qquad ( 7 )$$

Using the first equation in Eq. (5) and Eq. (6), and assuming LDPE for the vine material, the growth pressure of our everting compressed tail vine robot is then expressed as:

$${P}_{grow} = \frac{{kt}^{2}}{π ( {R}^{2} - {r}^{2} ) - {μ}_{\frac{VT}{WC}} 4 π r ( \frac{2 π RtL}{π ( {R}_{c}^{2} - {r}^{2} ) ϵ} )} . \qquad ( 8 )$$

For α∈[0,1], one can see that P_{grow} (αR,αr,αt)≥P_{grow} (R,r,t), meaning that a scaled-down everting compressed tail vine robot requires higher pressure to grow a given length. The gain in terms of growth length given by Eq. (7) greatly reduces the growth pressure at any given length and scale compared to standard everting designs. Interestingly, one can also see that when α tends to infinity, P_{grow} converges to

$$\frac{{kt}^{2}}{π ( {R}^{2} - {r}^{2} )} ,$$

which does not depend on e. This means that, as the scale increases, vines that are scaled relative to one another will grow at the same pressure, regardless of their compression ratio. These elements are key for practical use, as illustrated in the following example.

Consider a standard everting vine robot with r/R=0.1, μ_{VT/WC}=0.1, t/R=0.005, μ_{VT/vB}_{_{c}}=0.22, C=0.08, L=150 mm and a burst pressure of 61.3 kPa in the case of LDPE. For our simulations, one can assume R_{c}≈R. Using Eq. (8), the values of the pressure required to grow as a function of R as vine robots are scaled down were plotted.

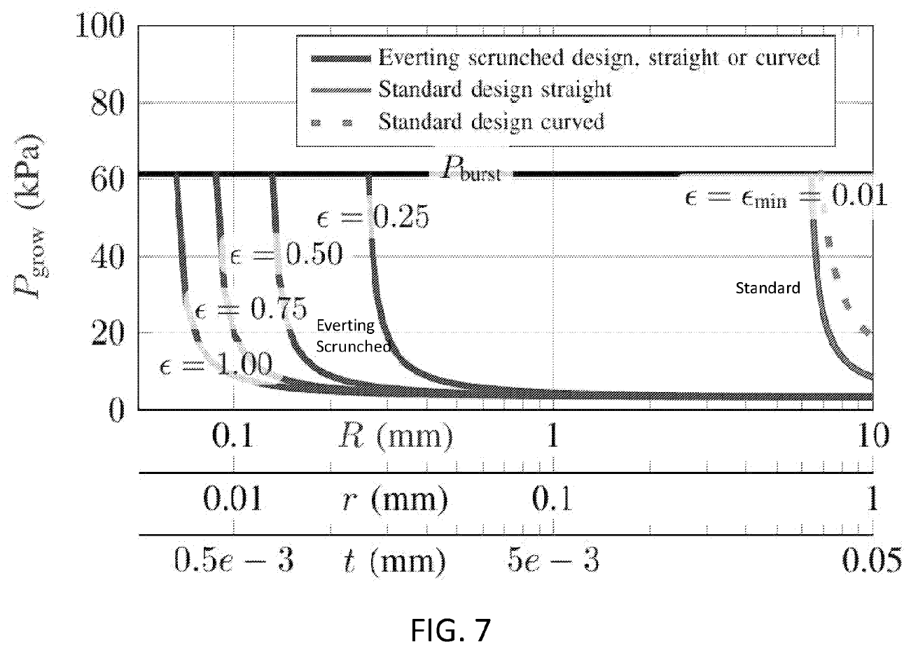

FIG. 7 shows pressure required to grow a 150 mm vine robot as it is scaled down, comparing the standard design to a present everting compressed tail (“scrunched”) design with different compression ratios (∈). While the standard design cannot grow for 150 mm for R≤6 mm, the compressed tail everting design succeeds, particularly when the compression ratio is high.

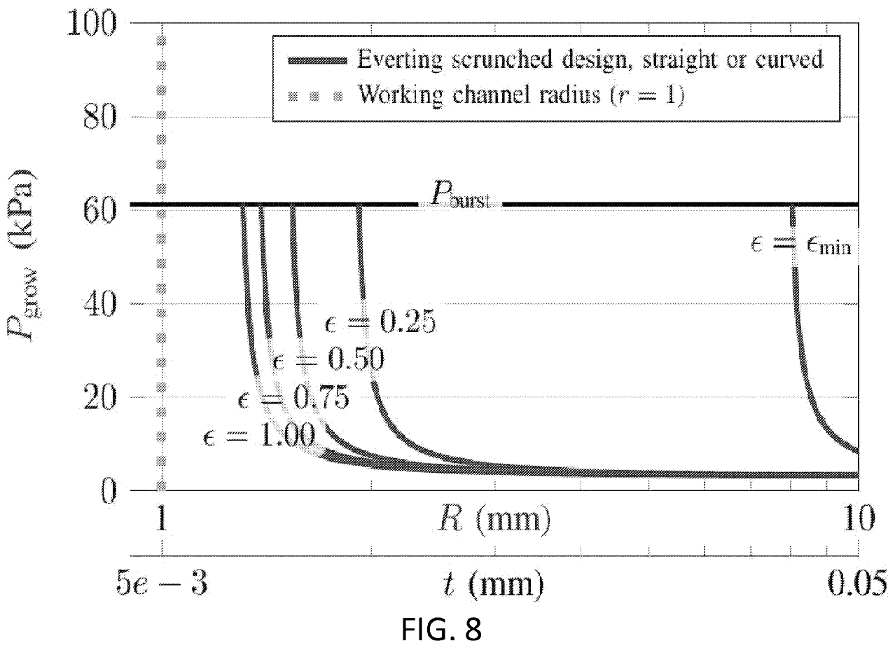

FIG. 8 shows pressure required to grow as a function of R as the body and material thickness of an everting compressed tail (“scrunched”) vine robot are scaled, while the working channel radius remains constant (r=1 mm). The graph shows that under these scaling conditions, the pressure required to grow increases as the vine robots are scaled down, and that working limits are reached with the present everting compressed tail design when the difference between R and r becomes too small.

Note that the uncertainty for various design parameters can be propagated to perform sensitivity analysis on the growth pressure if desired. As visible in FIG. 7, the standard design, which in the case of straight paths is equivalent to the compressed everting design with ∈=∈ₘᵢₙ, cannot grow for 150 mm for R 6 mm. For the standard design, the dependency on path curvature further increases the growth pressure and limits the growth length. In contrast, for a given radius R, the growth pressure the present everting compressed tail design decreases when E increases. Thus, the everting compressed tail vine robot enables growth at lower pressures, and the growth pressure does not depend on the path geometry. The model predicts that the growth pressures all converge to the same value as the scale increases. Finally, the growth pressure curves do intersect with the burst pressure line, meaning that below a certain radius, these vine robots cannot grow for a length of L=150 mm. Indeed, vine robots with ∈=0.5 cannot grow for 150 mm if R≤0.1 mm, while vine robots with ∈=0.75 or 1.00 can. Overall, the present everting compressed tail vine robot enables growth of robots that would otherwise not grow without the compressed tail portion.

### Non-Everting Compressed Tail Robot (202, FIGS. 2A-2C)

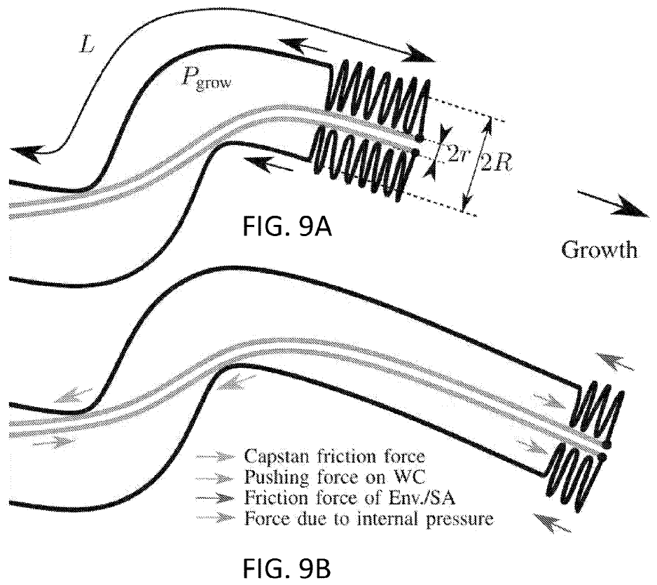

FIGS. 9A-9B illustrates forces for the non-everting compressed tail vine growing robot with a working channel at two different growth stages, with its design parameters represented in FIG. 9A and free body diagram representing the forces in FIG. 9B.

The robot 102 encounters a limit when the friction force between the tail and the working channel leads to an increase in growth pressure and decrease in growth length limits, particularly when the difference between the vine robot radius (R) and working channel radius (r) becomes small. In addition, the presence of the yield force, F_{y}, leads to an offset in the pressure required to grow, and can prevent the vine robot from growing if P_{burst}<P_{grow}. This condition occurs when R tends to r, in which case P_{grow} tends to infinity, while P_{burst} remains constant (see Eq. (4) and Eq. (8)).

The non-everting design has the distal end of the working tube attached to the distal end of the compressed portion. The body material decompresses and extends from the base of the compressed material portion, enabling deployment of the robot. Again assume that decompression of the material is not opposed by any force, i.e. that the material layers are not blocked due to the material being tightly packed. This design enables the elimination of the yield force and removes the friction force between the vine robot tail and the working channel.

These benefits come with a tradeoff, however, in that in the non-everting design, the compressed material at the distal tip undergoes rigid-body translation with respect to the environment. While this may not be as ideal as the everting design, it is shown below that the net resistance to growing can be reduced with the non-everting design. Further, root tips actually grow in this manner with a small section translating forward at the tip.

The analysis from above can be modified to understand the growth limits of the present non-everting compressed tail design. In this design, the working channel displacement is directly related to the vine robot deployment, since it is attached at the vine robot distal tip. Thus, the condition of deployment is expressed in a single equation, given as:

$$\frac{1}{2} {P}_{grow} π ( {R}^{2} - {r}^{2} ) + {F}_{Push} = {F}_{WC / VB} + {F}_{Env . / SA} , \qquad ( 9 )$$

where F_{Push} is the force applied at the base of the working channel, F_{WC/VB} is the friction force between the working channel and the vine body, and F_{Env./SA} is the friction force between the environment and the scrunched material. Note that in this design, since the working channel is attached to the distal tip of the vine material, F_{Push} can exceed F_{WC/VB} in magnitude and lead to growth without significant internal pressure.

This friction force can be expressed as:

$${F}_{Env . / SA} = {μ}_{Env . / SA} {F}_{Env . / SA}^{NS} {A}_{SA} , \qquad ( 10 )$$

where μ_{Env./SA} is the friction coefficient between the environment and the scrunched area,

$${F}_{Env . / SA}^{NS}$$

is the normal surface force between them, and A_{SA} is the surface of the scrunched area. It is possible to express A_{SA} as a function of the vine robot radius (R), length of material scrunched (L), material thickness (t), working channel radius (r), and compression ratio (E).

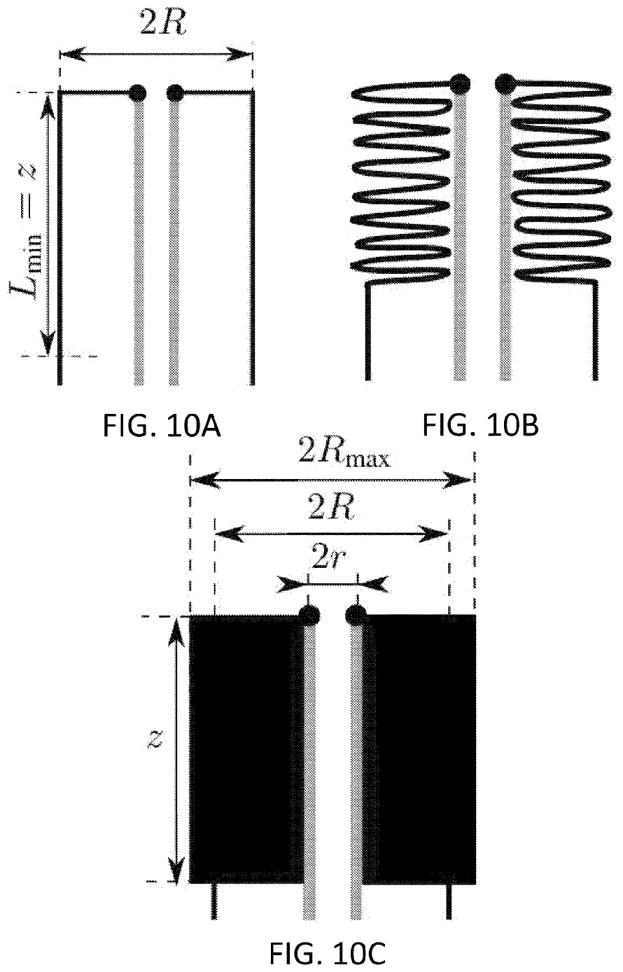

FIGS. 10A-10C shows representations of the compressed material for ∈=∈ₘᵢₙ (i.e. no scrunching), ∈=1 (most compact), and an intermediate case.

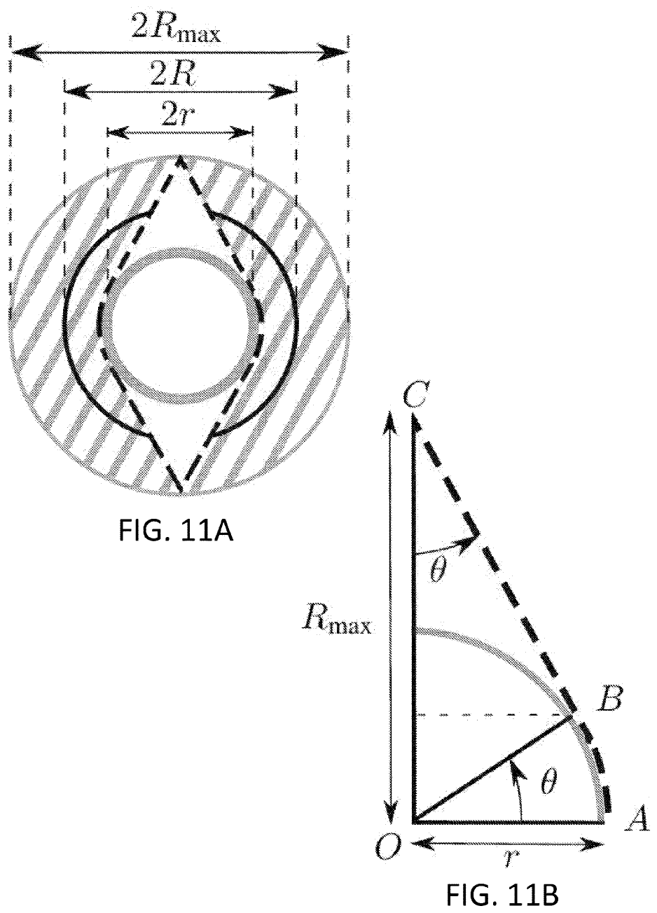

FIGS. 11A-11B show (A) front view in the growth direction of the non-everting compressed vine robot, in the case of compressed material with the highest compression ratio (∈=1), and (B) close up view which shows additional design parameters for modeling purposes.

In its most compact form, the compressed material occupies a maximum radius Rₘₐₓ, due to the arrangement of the material around the working channel. In order to estimate the radius Rₘₐₓ, the angle θ, represented in FIG. 111B, must first be identified. Consider a point B=[r cos θ r sin θ]^{T} on the circle. The intersection between the tangent of the circle at point B and the vertical axis that intersects with O is

$$C = {[ 0 \frac{r}{sin θ} ]}^{T} .$$

Knowing that the length of the arc from A to C, AC, is a quarter of the vine robot body perimeter, and knowing the location of points B and C, write [symbol] = [symbol] + [symbol] as:

$$\frac{2 π R}{4} = r ( θ + \sqrt{\frac{1}{{sin}^{2} θ} - 1} ) . \qquad ( 11 )$$

Solving Eq. (11) for θ, the maximum compressed radius, Rₘₐₓ, can then be calculated as:

$${R}_{max} = \frac{r}{cos θ} \sqrt{\frac{1}{{sin}^{2} θ} - 1} . \qquad ( 12 )$$

It is convenient to convert the length of scrunched material at the tip, z, to a deployed length, L, for the vine robot. Similar to the compressed tail everting design, the compression ratio ∈ is computed as the ratio of volume occupied by the vine robot material over the available volume as:

$$ϵ = \frac{2 π RtL}{π ( {R}_{max}^{2} - {r}^{2} ) z} . \qquad ( 13 )$$

The minimum length of material that can be stored corresponds to a single layer (no fold/scrunch) being present in the tail area. This corresponds to Lₘᵢₙ=z, as represented in FIG. 10A, leading to a minimum compressing ratio

$${ϵ}_{min} = \frac{2 Rt}{{R}_{max}^{2} - {r}^{2}} .$$

In this case, the surface of the compressed area is

$${A}_{SA} {=}^{max} {A}_{SA , max} = 2 π RL .$$

In its most compact format, the compressed area is full of material and ∈=1, resulting in

$${A}_{SA} = {A}_{SA , min} = \frac{4 π {R}_{max} RtL}{{R}_{max}^{2} - {r}^{2}} .$$

It is interesting to observe that, in Eq. (13) as z decreases to

$$\frac{L}{{2}^{n}}$$

with n∈ [symbol] , ∈ increases using the law ∈=∈ₘᵢₙ2ⁿ.

In order to express A_{SA}, assume that it follows a similar trend, such that as z decreases to

$$\frac{L}{{2}^{n}}$$

with n∈ [symbol] , A_{SA} decreases from its initial value by a factor of 2ⁿ, and is written as A_{SA}=A_{SA,max} 2⁻ⁿ=2πRL x 2⁻ⁿ. This assumption holds if the radius of the compressed area remains approximately constant and equal to R while its length decreases. Although the radius actually varies between R and Rₘₐₓ, because Rₘₐₓ cannot be greater than

$$\frac{π R}{2} \approx 1.57 R$$

(for the case when r=0), this assumption is reasonable. Since ∈=∈ₘᵢₙ2ⁿ, A_{SA} can be expressed as a function of ∈:

$${A}_{SA} = 2 π ( L - {L}_{dep} ) R \times {2}^{( - \frac{log ( \frac{ϵ}{{ϵ}_{min}} )}{log ( 2 )} )} \qquad ( 14 )$$

where L_{dep} is the length of material that has already been deployed. As shown in Eq. (14), the surface of compressed material is maximal at the beginning of the deployment when L_{dep}=0, and equals zero at the end of the deployment, where L_{dep}=L. Thus, the potential surface of friction between the vine robot and the environment decreases as the robot deploys. Since the non-everting compressed tail design can be grown at lower pressure by pushing the working channel (see Eq. (9)), focus the simulations on A_{SA}, which impacts the friction force between the vine robot and the environment.

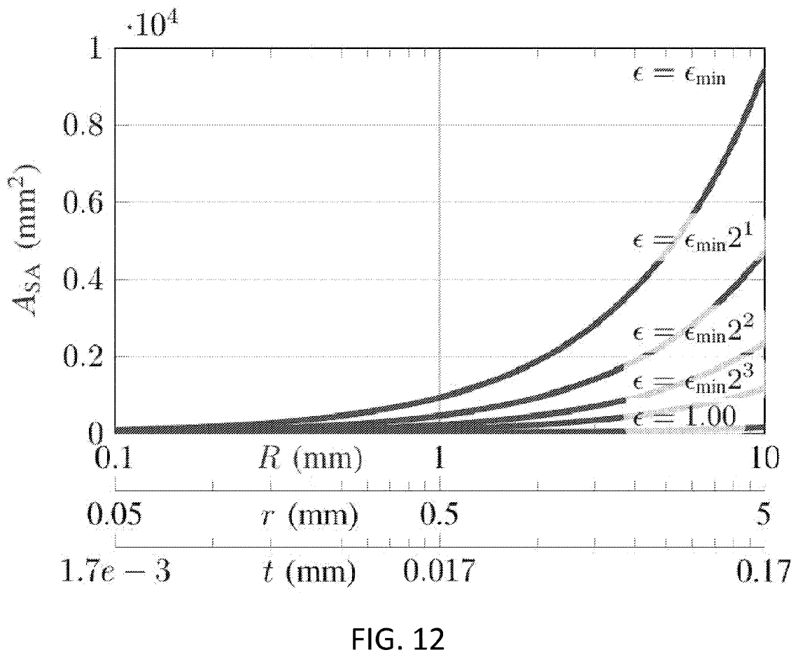

To investigate how A_{SA} varies as a vine robot is scaled, consider a vine robot made of LDPE with r/R=0.5, t/R=0.017, L=150 mm. Compute the compressed area, A_{SA}, when the vine robot is fully retracted, i.e. L_{dep}=0. In Eq. (11), it is visible that if the ratio r/R is fixed, the angle θ remains constant as vine robots are scaled down. In Eq. (12), one can see that Rₘₐₓ then becomes a linear function of r, which leads to A_{SA} varying linearly as a function of the scaling ratio. This relationship is illustrated in FIG. 12.

FIG. 12 specifically shows variations of compressed material area as a function of R as the vine robot is scaled down, for different compression ratios e. For all compression ratios, the area of compressed material decreases as the non-everting compressed tail vine robot is scaled down, and as the compression ratio increases.

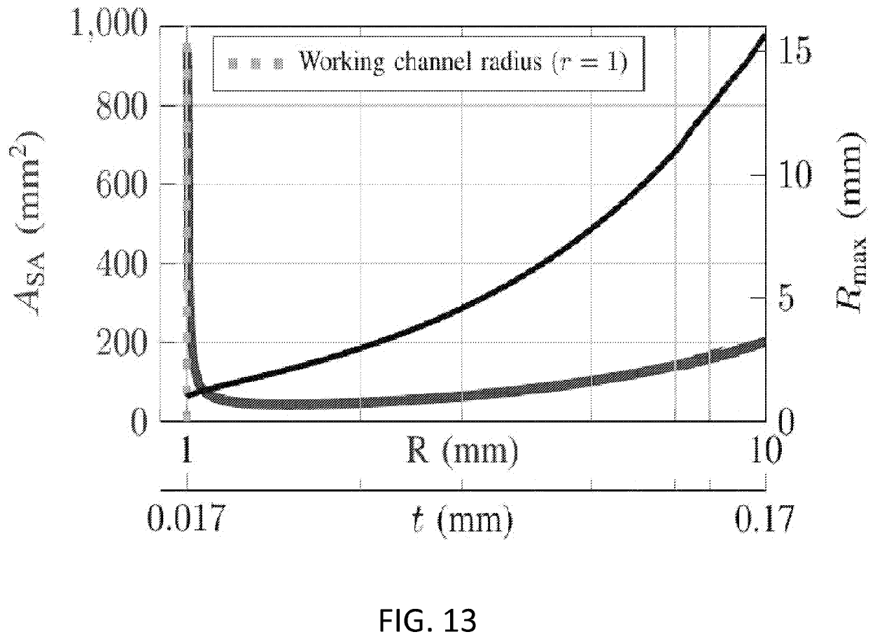

FIG. 13 shows variations of Rₘₐₓ and A_{SA} when the vine robot body and material thickness are scaled, while the working channel radius remains constant (r=1 mm), for a compression ratio of ∈=1. For R>1.2 mm, the radius of the compressed material, Rₘₐₓ, increases, while the compressed area, A_{SA}, remains relatively constant, showing that the radius of compressed material can be controlled to be small without increasing its exposed surface by selecting a proper scaling ratio.

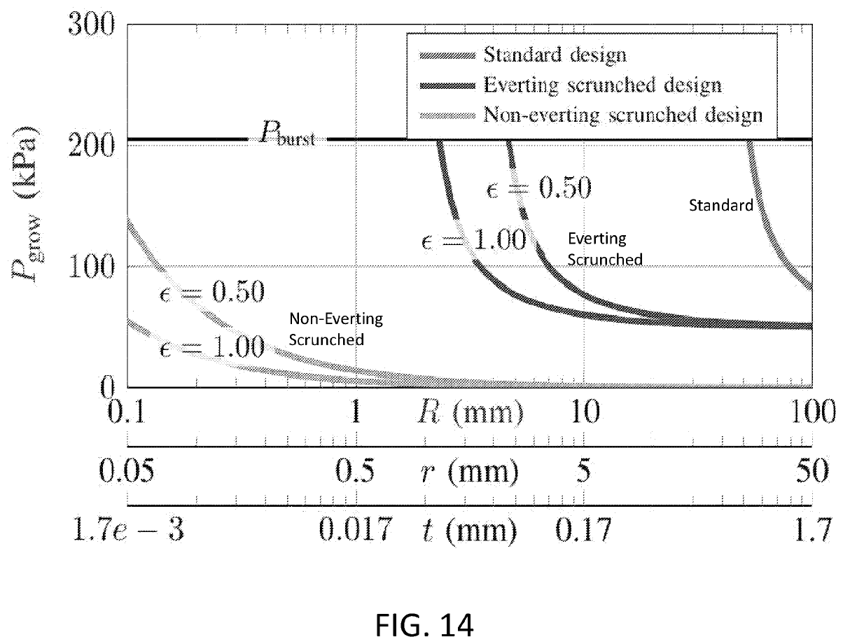

FIG. 14 is a comparison of the pressure required to grow a 150 mm vine robot as it is scaled down, for the standard design, the everting compressed tail design, and the non-everting compressed tail design. While the standard design cannot grow for 150 mm for R≤50 mm, both of the present compressed tail designs can. The everting compressed tail robot cannot grow for R≤2 mm, but the non-everting compressed robot succeeds depending on the friction force with the environment, particularly when the compression ratio is high.

The simulation data of FIG. 14 considers a practical case where application requirements constrain the radius of the working channel, and a robot body as small as possible is desired. Thus, assess how scaling the vine robot body and material thickness affect the geometry of the scrunched area, for a compression ratio of ∈=1, which is the most favorable to lower the surface of contact with the environment. The vine robot material is LDPE with t/R=0.017, L=150 mm, as in the previous study, and set r=1 mm. They show that as R is scaled down towards r, Rₘₐₓ continuously decreases. A_{SA} also decreases slightly initially but experiences a sharp increase for R<1.2 mm. Indeed for R<1.2 mm, there is a clear trade-off between minimizing the potential surface of friction and maintaining a small overall diameter. However, for R>1.2 mm, the compressed area, A_{SA}, only increases slightly, even as the radius of the compressed material, Rₘₐₓ increases. This shows that Rₘₐₓ does not need to be constrained to be small to obtain small values of A_{SA}, by selecting the proper scaling ratio.

### Fabrication of the Everting Compressed Tail Robot (102, FIGS. 1A-IC)

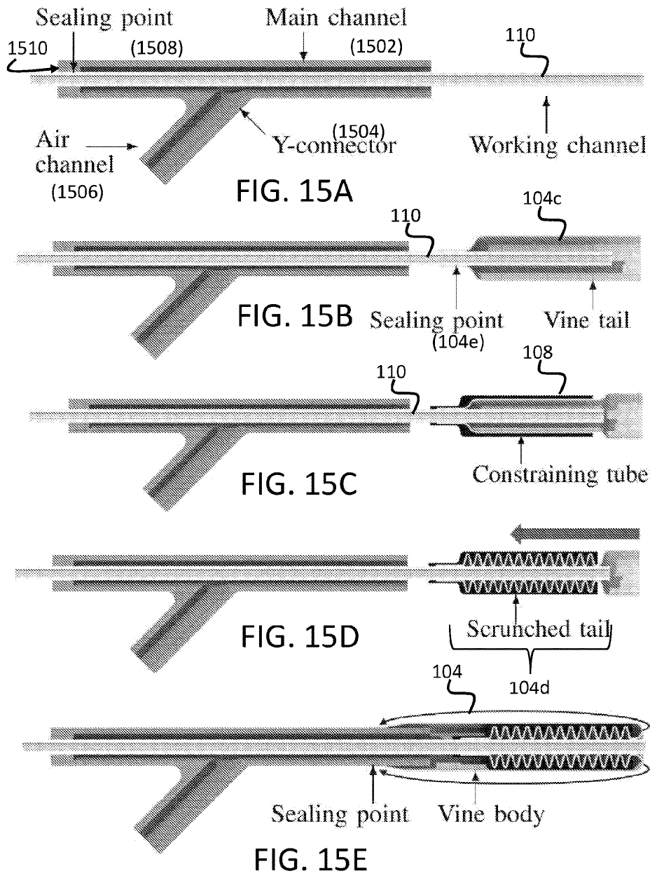

FIGS. 15A-15E show a preferred fabrication process for the everting compressed tail robot 102. In FIG. 15A, the working channel 110 is first inserted through the main channel 1502 of a Y-connector 1504, and an air line is connected to its side channel 1506. The working channel is sealed at a sealing point 1508, which is at a based of the Y-connector 1510. Clearance between the main channel of the Y-connector and the working channel enables air to travel around the working channel to pressurize the vine robot, and an air-seal prevents leakage at the base 1510 of the Y-connector. In FIG. 15B, the tail portion 104c is attached and sealed to the working tube 110 at connection point 104e. In FIG. 15C, the constraining tube 108 is placed around a portion of the tail 104c and attached to the working tube 110 at connection point 104e. In FIG. 15D, the compressed (“scrunched”) portion 104d is formed, using a compression tube that fits between the working channel 110 and the constraining 108 tube pressed the tail 104c to form folds/scrunches and increase its compression ratio. In step 15E, the robot body 104 is pulled back over the constraining tube and is attached to the Y-connector. The entire robot body 104 is pulled back from its base over the constraining tube 108 such that the complete inverted state prior to deployment is achieved. The Y-connector can itself form part of a vine robot system of the invention. It is a rigid piece that allows the passage of the working channel such that it is accessible by operators and so that tools can be inserted inside. It also enables the supply and passage of the fluid between the working channel and the vine body, while ensuring sealing.

### Fabrication of the Non-Everting Compressed Tail Robot (202, FIGS. 2A-12C)

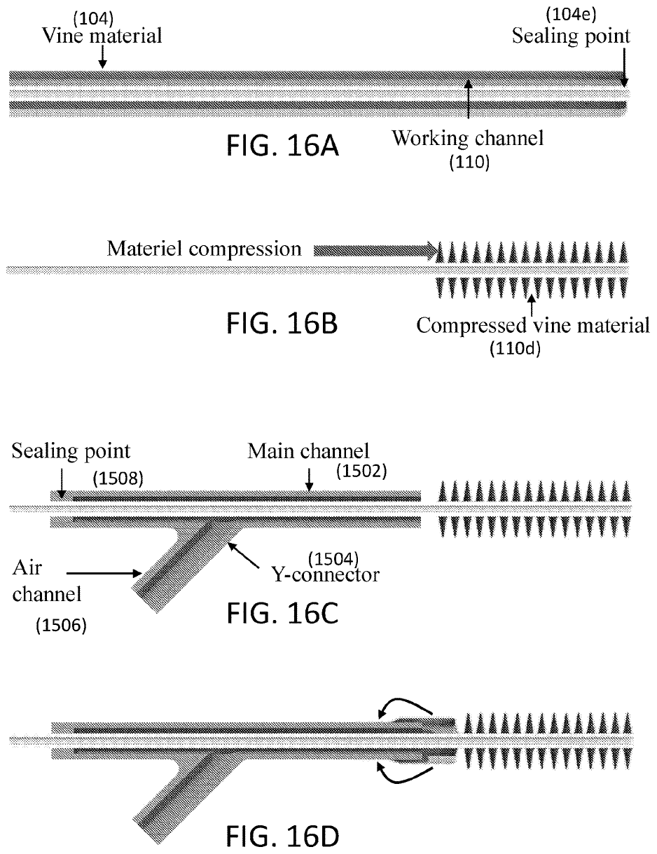

The non-everting compressed tail robot 202 can be formed by the steps of FIGS. 16A-16D. In FIG. 16A, the working tube 110 is inserted in the vine body 104 and is attached at the sealing/attachment point 104e. FIG. 16B shows the compressed tail portion 104d. In FIG. 16B, the other body portions of the vine robot are omitted for the sake of illustrating the compression. While not shown, a constraining tube can be optionally used to inhibit radial expansion of the compressed portion 104d. In FIG. 16C, the working tube 110 is inserted in the Y-connector 1504 and sealed at the sealing point 1508. In FIG. 16D, a proximal portion of the robot body 104 is sealed to the Y-connector 1504. With respect to use of a constraining tube in this design, a benefit of omitting the constraining tube is that the surface of friction between the environment and the compressed tail portion decreases during deployment. Indeed, the length of the scrunched material storage area decreases as the material deploys. However, the vine tail with the scrunches usually takes a larger diameter than the vine body, which increases space requirement compared to a design that includes a constraining tube. The benefit of the use of a constraining tube is that the diameter of the compressed tail portion can be constrained to lower diameters comparable to the diameter of the remaining body.

### Experimental Compressed Tail Robots

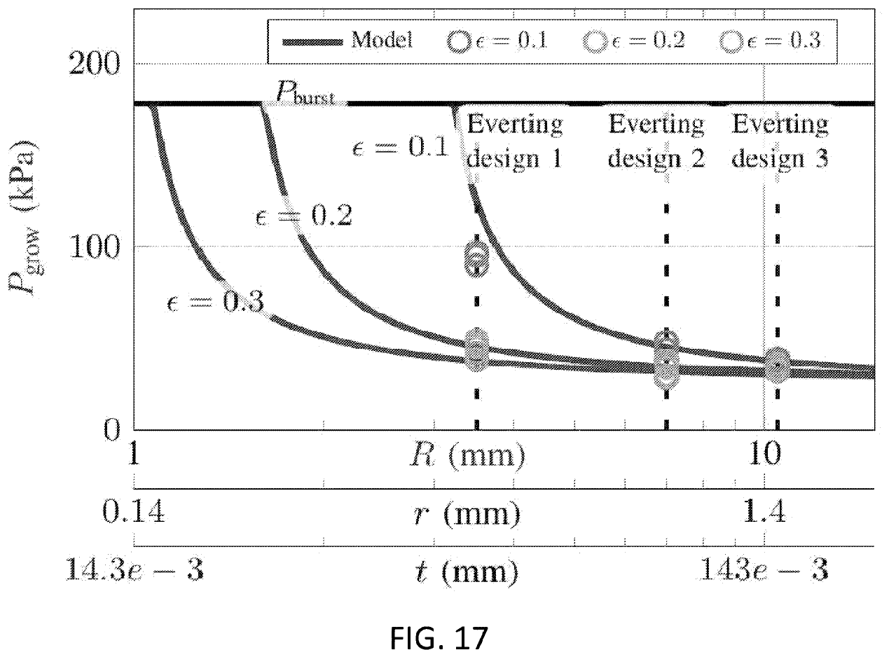

FIG. 17 shows testing data of surface area of scrunched material as a function of compression ratio for three experimental everting compressed tail robots. The data are scaled relative to one another (Everting design 1 of radius 3.5 mm, Everting design 2 of radius 7.0 mm, Everting design 3 of radius 10.5 mm), for a deployed length of 100 mm, for compression ratios ∈=0.1, 0.2 and 0.3. The three vine robots were then fabricated and assembled with three different compression ratios each (∈=0.1, ∈=0.2 and ∈=0.3) and grown three times for a length of 100 mm. The compression ratios correspond to lengths z=29.2, 14.6 and 9.7 mm, respectively.

Human-in-the-loop deployment with visual feedback was used to keep the working channel at the tip, with the user manually controlling both the internal vine pressure and the working channel displacement. The average pressure required to obtain this length of growth was measured and is shown in FIG. 17, along with the expected pressures required to grow 100 mm as a function of R based on the model. Larger errors are observed for the smallest design (everting design 1) with the smallest compression ratio ∈=0.1. These larger errors could be explained by modeling inaccuracies of the surface of contact between the vine tail and the working channel at such a small scale. However, overall, the experimental results are in general agreement with the above simulations, validating the down-scaling capability of the everting compressed tail vine robot.

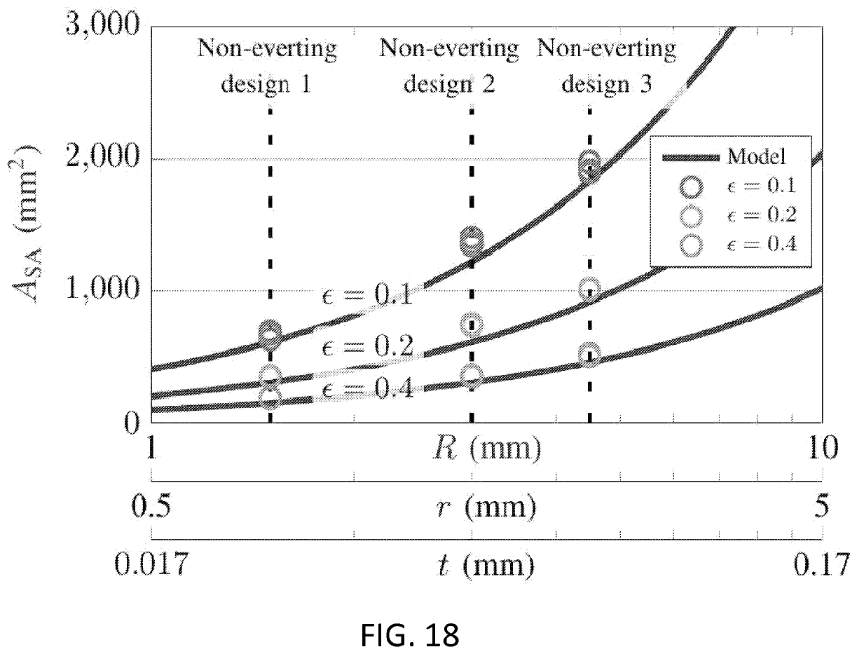

FIG. 18 shows testing data of required pressures to grow three experimental non-everting compressed tail robots. The data are scaled relative to one another (Non-everting design 1 of radius 1.5 mm, Non-everting design 2 of radius 3.0 mm, Non-everting design 3 of radius 4.5 mm), for a deployed length of 150 mm, for compression ratios ∈=0.1, 0.2 and 0.4, to estimate the surface area, assuming a cylindrical shape. This process was performed 3 times for each vine design at each compression ratio. FIG. 18 also shows values predicted by the model in Eq. (14). The experimental data closely follow the model predictions, which is useful for predicting the surface of contact with the environment.

The robots of the invention advance the state of the art. Example dimensions for the everting scrunched design can have diameters of about 10-20 mm with a deployment of a few meters. A vine prototype for colonoscopy which was 13 mm in outer diameter and deployed for 1.5 meters. Larger diameters permit longer deployed length for the same working channel diameter and vine robot material. Example dimension for the non-everting design are one to a few millimeters (e.g., 1.5-7 mm or less than 4-5 mm) in diameter for a few meters in deployed length. The performance will depend on the friction between the scrunched area and the environment. As an example, a vine robot which was 2.22 mm in diameter for the body and 3.20 mm for the scrunched part was fabricated, which was deployed for 350 mm. Lengths of a 100 mm to a few meters are provided by both the everting and non-everting vine robots of the invention.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A soft vine robot, comprising:
a soft main body having a base portion, a middle portion and a tail portion, the main body being configured to grow into a constrained environment with the tail portion extending further into the constrained environment than the middle and base portions;
a compressed portion in the tail portion, the compressed portion being configured to decompress, and extend into the constrained environment.

2. The soft vine robot of claim 1, comprising a working channel.

3. The soft vine robot of claim 1, comprising a constraining tube around the compressed portion.

4. The soft vine robot of claim 3, wherein the constraining tube comprises non-stretchable material.

5. The soft vine robot of claim 3, wherein the constraining tube is configured to resist radial expansion of the compressed portion.

6. The soft vine robot of claim 3, wherein the soft main body and the constraining tube are formed of the same material.

7. The soft vine robot of claim 6, wherein the constraining tube is formed of thicker material than material of the soft main body.

8. The soft vine robot of claim 3, wherein one or both of the soft main body and the constraining tube comprise fiber reinforced fabric.

9. The soft vine robot of claim 3, wherein the constraining tube is configured to withstand radial expansion forces from the compressed portion.

10. The soft vine robot of claim 3, comprising a connector attached to a proximal end of the soft main body, the connector providing a fluid pressure lumen.

11. The soft vine robot of claim 10, wherein the connector comprises a second lumen, wherein the working channel extends through the second lumen.

12. The soft vine robot of claim 3, wherein the constraining tube is attached to the working channel.

13. The soft vine robot of claim 1, wherein the soft main body is configured as a non-everting body.

14. The soft vine robot of claim 1 wherein the soft main body is configured as an everting body.

15. The soft vine robot of claim 14, wherein the soft main body is configured as a tube inverted back inside itself to define a pressure channel, such that when the channel is pressurized, the main body everts, and inverted material of the main body everts and passes out of a tip at a distal end of the main body.

16. The soft vine robot of claim 1, comprising a controlled pressure source in fluid communication with the soft main body.

17. The soft vine robot of claim 1, wherein the soft main body has a diameter configured to allow insertion in a targeted environment.

18. The soft vine robot of claim 1, having a length of at least 100 mm.

19. The soft vine robot of claim 18, having a length of more than a meter.

20. A method of using a soft vine robot, the method comprising inflating the soft main body of the soft vine robot of claim 1 with a fluid to extend said soft main body into the constrained environment; and decompressing the compressed portion in the tail portion of the soft main body to extend further into the constrained environment.
